(19) United States
(12) Patent Application Publication
(10) Pub. No.: US 2015/0171653 A1
(43) Pub. Date: Jun. 18, 2015

(54) MOBILE POWER

(71) Applicant: Shenzhen Hello Tech Energy Co., Ltd., Shenzhen (CN)

(72) Inventor: Meichan Wen, Shenzhen (CN)

(73) Assignee: Shenzhen Hello Tech Energy Co., Ltd., Shenzhen (CN)

(21) Appl. No.: 14/205,470

(22) Filed: Mar. 12, 2014

(30) Foreign Application Priority Data
Dec. 18, 2013 (CN) 201320839659.7

(51) Int. Cl. H02J 7/00

(52) U.S. Cl. CPC H02J 7/0054; H02J 7/0042

(57) ABSTRACT

A mobile power for a digital device includes: a first housing, a rechargeable battery; a main PCB; a LCD module; and a storage module. The main PCB includes: a charging input interface configured to charge the rechargeable battery; a charging management circuit configured to control charging and discharging of the rechargeable battery; and a boost circuit configured to elevate an output voltage of the rechargeable battery to a required voltage for digital device charging; and a charging output interface configured to be connected to the digital device. The storage module includes: a semiconductor media storage unit configured to store data; and a control unit configured to read data of the digital device and write the data to the semiconductor media storage unit.

### FIELD OF THE INVENTION

The present disclosure relates to electronic devices, and more particularly relates to a mobile power having a storage feature.

### BACKGROUND OF THE INVENTION

As the continuous economic development and progress, digital devices, such as laptops, tablet PCs, mobile phones, digital cameras, camcorders, portable DVD, PDA, MP3, MP4, GPS and etc., are continuously created. Although these digital devices have become more and more powerful, their batteries can not meet the needs for prolonged use. Mobile power is a portable charger with power supply and charging functions for mobile phones and other digital devices. The mobile power usually contains lithium batteries, which are relatively compact and have large capacity, thus it is widely used for digital products.

However, the conventional mobile power only has a charging ability, which is unable to meet the growing various requirements of mobile digital devices. Therefore, there is room for improvement within the art.

### SUMMARY OF THE INVENTION

The present disclosure is directed to a mobile power having a storage feature.

A mobile power for a digital device includes: a first housing; a rechargeable battery; a main Printed Circuit Board (PCB) fixed to the first housing, wherein the main PCB includes: a charging input interface configured to charge the rechargeable battery; a charging management circuit configured to control the charging and discharging of the rechargeable battery; and a boost circuit configured to elevate an output voltage of the rechargeable battery to a required voltage for charging digital device; and a charging output interface configured to be connected to the digital device; a Liquid Crystal Display (LCD) module disposed on the main PCB configured to display a charge and discharge information of the mobile power; a storage module disposed on the main PCB, wherein the storage module includes: a semiconductor media storage unit configured to store data; and a control unit configured to read data of the digital device and write the data to the semiconductor media storage unit; and a second housing having a cavity, wherein the second housing is fixed to the first housing such that the rechargeable battery and the main PCB are received in the cavity.

In one embodiment, the mobile power further includes a LCD lens disposed on the first housing and aligned with the LCD module.

In one embodiment, the mobile power further includes a button disposed on the first housing, wherein the button is electrically coupled to the main PCB and is configured to switch on the power output to the digital device and activate the battery capacity inquiry.

In one embodiment, the mobile power further includes a pad having one side attached to the main PCB and the other side attached to the LCD module.

In one embodiment, the mobile power further includes a first fastener, wherein the main PCB is fixed to the first housing by the first fastener.

In one embodiment, the LCD module is provided with a first pin connector, the LCD module is coupled to the main PCB via the first pin connector.

In one embodiment, the storage module is provided with a second pin connector, the storage module is coupled to the main PCB via the second pin connector.

In one embodiment, the rechargeable battery is a three-cell battery, the rechargeable battery is attached to the second housing and is electrically coupled to the main PCB via wires.

In one embodiment, the first housing is provided with a latching portion on an edge thereof, the second housing is provided with an engaging portion on an edge thereof cooperating with the latching portion.

A storage module is integrated to the mobile power, thus the mobile power not only has a charging ability, but also has a removable storage function.

These and other objects, advantages, purposes and features will become apparent upon review of the following specification in conjunction with the drawings.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is an exploded perspective view of an embodiment of a mobile power;

FIG. 2 is a schematic block diagram of the main PCB of FIG. 1;

FIG. 3 is a schematic block diagram of the storage module of FIG. 1.

### DETAILED DESCRIPTION OF THE EMBODIMENTS

Reference will now be made to the drawings to describe, in detail, embodiments of the present back-up power supply for mobile phone. It should be noted that references to “an” or “one” embodiment in this disclosure are not necessarily to the same embodiment, and such references mean at least one.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,”“above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

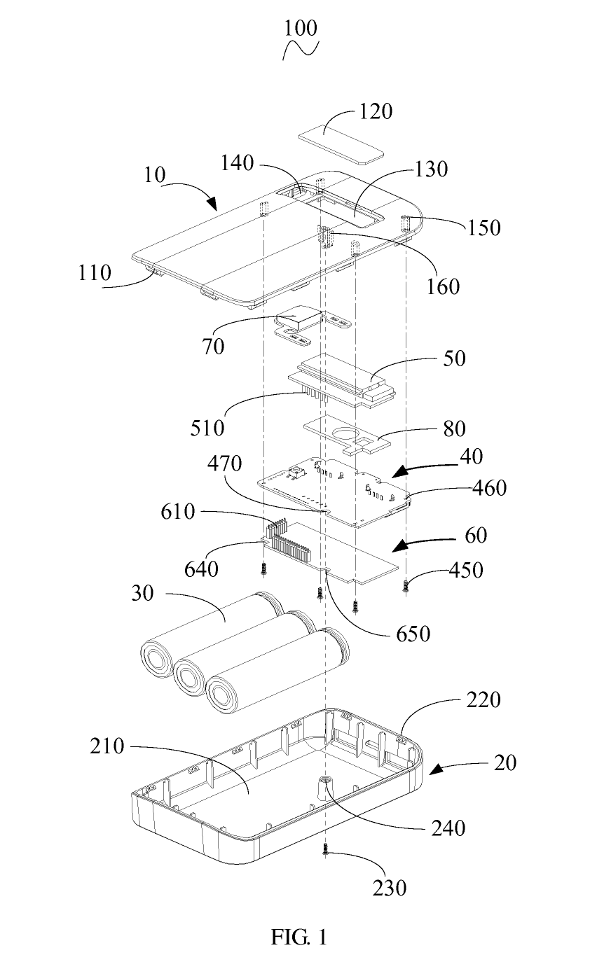

Referring to FIG. 1, an embodiment of a mobile power 100 is used to provide power to digital devices, such as mobile phone, or camera and the like. The mobile power 100 includes a first housing 10, a second housing 20, a rechargeable battery 30, a main PCB (printed circuit board) 40, a LCD (liquid crystal display) module 50, and a storage module 60.

The first housing 10 is shaped as a rectangular board, which is used to be latched with the second housing 20 to form a shell of the mobile 100. The first housing 10 defines a first opening 130 and a second opening 140, which are adjacent. The first housing 10 is provided with a plurality of latching portions 110 on an edge thereof.

The second housing 20 is shaped as a rectangular case. The second housing 20 defines a cavity 210 therein. The second housing 20 is provided with a plurality of engaging portions 220 on an edge thereof cooperating with the latching portion 110. The second housing 20 is fixed to the first housing 10 by engaging the latching portions 110 with the engaging portions 220, such that the rechargeable battery 30 and the main PCB 40 are received in the cavity 210. In order to make a firmly engagement between the first housing 10 and the second housing 20, the plurality of latching portions 110 are evenly distributed on the edge of the first housing 10, while the plurality of engaging portions 220 are evenly distributed on the edge of the second housing 20.

In the illustrated embodiment, the rechargeable battery 30 is a three-cell battery. The cell of the rechargeable battery 30 may be a lithium cell or a polymer cell. The rechargeable battery 30 is received in the cavity 210 of the second housing 20 by a double-sided adhesive and is electrically coupled to the main PCB 40 via wires.

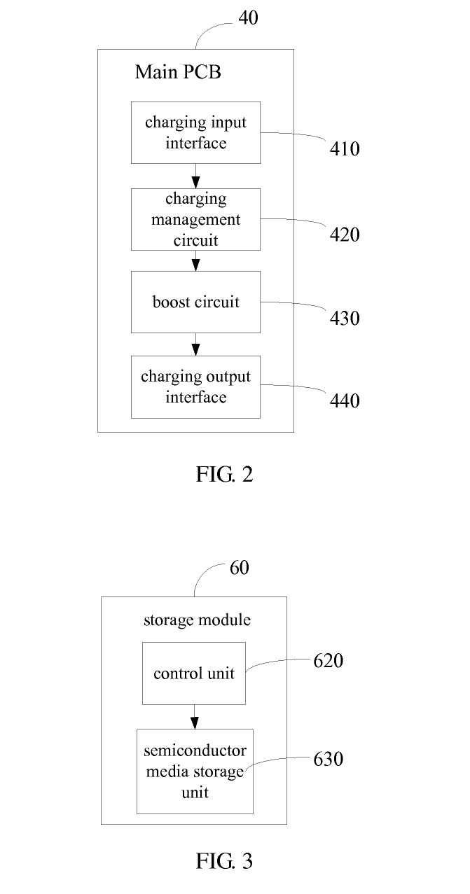

Referring also to FIG. 2, the main PCB 40 includes a charging input interface 410, a charging management circuit 420, a boost circuit 430, and a charging output interface 440. The charging input interface 410 may be coupled to an external power adapter for charging the rechargeable battery 30. The charging input interface 410 may be a Mirco-USB connector, a Mini-USB connector or a Lightning connector, which is a proprietary computer bus and power connector created by Apple Inc.. The charging management circuit 420 is electrically coupled to the rechargeable battery 30 and is configured to control the charging and discharging of the battery 30. The charging management circuit 420 can also test the battery capacity by means of voltage or current. The boost circuit 430 is electrically coupled to the rechargeable battery 30 and is configured to elevate an output voltage of the rechargeable battery 30 to a required voltage for charging the digital devices. The charging output interface 440 is coupled to the boost circuit 430 via wires and is used to be connected to the digital devices. The charging output interface 440 may be a Mirco-USB connector, a Mini-USB connector or a Lightning connector.

The LCD module 50 is fixed to the main PCB 40 corresponding to the first opening 130 of the first housing 10. The LCD module 50 is provided with a first pin connector 510 and is electrically coupled to the main PCB 40 via the first pin connector 510. The LCD module 50 is used to display a charge and discharge information of the mobile power 100, e.g. the remaining battery power and charging indicator. In the illustrated embodiment, the mobile power 100 further includes a LCD lens 120, which is a transparent glass plate or plastic plate. The LCD lens 120 can be amounted to the first opening 130 of the first housing 10 by a double-sided adhesive. The LCD lens 120 can protect a screen of the LCD module 50 from dust, water droplets and other effects.

The storage module 60 is fixed to the main PCB 40. The storage module 60 is provided with a second pin connector 610 and is electrically coupled to the main PCB 40 via the second pin connector 610. The number of the second pin connector 610 may be two. Referring to FIG. 3, the storage module 610 includes a control unit 620 and a semiconductor media storage unit 630. The control unit 620 is used to read data of the digital device and write the data to the semiconductor media storage unit 630. The semiconductor media storage unit 630 is used to store data.

In the illustrated embodiment, the mobile power 100 further includes a button 70. The button 70 is mounted on the main PCB 40 by plastic hot melting and extends through the second opening 140 of the first housing 10. The button 70 is electrically coupled to the main PCB 40, such that the user can press the button 70 to switch on the power output to the digital device and activate the battery capacity inquiry. The outer surface of the button 70 is adapted to the shape of the surface of the first housing 10, such that when the button 70 extends through the second opening 140, the outer surface of the button 70 and the surface of the first housing 10 forms a seamless surface.

In the illustrated embodiment, the mobile power 100 further includes a pad 80, which has a matching shape as that of the LCD module 50. The pad 80 is made of ethylene-vinyl acetate (EVA) copolymer and is used to fix and support the LCD module 50. One side of the pad 80 is attached to the main PCB by a double-sided adhesive, while the other side of the pad 80 is attached to the LCD module 50.

In the illustrated embodiment, the mobile power 100 further includes four first fasteners 450. The first housing 10 is provided with four threaded columns 150, and the main PCB 40 defines four through holes 460 at the corners. The four first fasteners 450 extends through the four through holes 460 and are threadly engaged the four threaded columns 150, respectively, such that the main PCB 40 is fixed to the first housing 10 by the first fasteners 450. The storage module 60 defines two first notches 640 to allow the first fasteners 450 to go through. It is to be understood that, the number of the first fasteners 450, threaded columns 150, and the through holes 460 may be wildly varied and not limited to four. The through holes 460 may be not limited to be defined at the four corners of the main PCB 40.

In the illustrated embodiment, the mobile power 100 further includes a second fastener 230. The second housing 20 is provided with a positioning column 240. The first housing 10 is provided with a threaded columns 160 corresponding to the positioning column 240. The second fastener 230 extends through the positioning column 240 and is threadly engaged the threaded columns 160, such that the first housing 10 and the second housing 20 are fixed together. The storage module 60 defines a second notch 650 on an edge thereof to allow the second fasteners 230 to go through. The main PCB defines a third notch 170 on an edge thereof to allow the second fasteners 230 to go through. It is to be understood that, the number of the second fasteners 230 may be more than one. The numbers and places of the positioning column 240 and the threaded columns 160 may be varied accordingly.

In assembly, both sides of the pad 80 are coated with double-sided adhesives, then ones side of the pad 80 is attached to the LCD module 50. The first pin connector 510 of the LCD module 50 is inserted into the main PCB 40, thus the LCD module 50 is fixed to the main PCB 40. The second pin connector 610 of the storage module 60 is inserted into the main PCB 40, thus the storage module 60 is fixed to the main PCB 40. Then the main PCB 40 is fixed to the first housing 10 by the first fasteners 450. After that, the LCD lens 120 is attached to the first housing 10 by a double-sided adhesive, and the button 70 is mounted on the main PCB 40 by plastic hot melting. The rechargeable battery 30 is received in the cavity 210 of the second housing 20 by a double-sided adhesive and is electrically coupled to the main PCB 40 via wires. Finally, the second housing 20 is fixed to the first housing 10 by engaging the latching portions 110 with the engaging portions 220 and threadly engaging the second fastener 230. The assembly of the mobile power 100 is completed.

Since the mobile power 100 according to the present disclosure has a main PCB 40 and a rechargeable 30, it has a charging ability for digital devices such as mobile phones and tablet PCs, thus it can extend the standby time of the mobile phones and tablets. On the other hand, the mobile power 100 has a storage module 60, such that it has mobile data storage function, data of the mobile phones and tablet computers can be stored simply during the charging, and there is no need to use a computer to dump data from mobile phones and tablet PCs.

Although the present invention has been described with reference to the embodiments thereof and the best modes for carrying out the present invention, it is apparent to those skilled in the art that a variety of modifications and changes may be made without departing from the scope of the present invention, which is intended to be defined by the appended claims.

What is claimed is:

1. A mobile power for a digital device, comprising:
a first housing;
a rechargeable battery;
a main Printed Circuit Board (PCB) fixed to the first housing, wherein the main PCB comprises:
a charging input interface configured to charge the rechargeable battery;
a charging management circuit configured to control charging and discharging of the rechargeable battery; and
a boost circuit configured to elevate an output voltage of the rechargeable battery to a required voltage for charging the digital device; and
a charging output interface configured to be connected to the digital device;
a Liquid Crystal Display (LCD) module disposed on the main PCB configured to display
a charge and discharge information of the mobile power;
a storage module disposed on the main PCB, wherein the storage module comprises:
a semiconductor media storage unit configured to store data; and
a control unit configured to read data of the digital device and write the data to the semiconductor media storage unit; and
a second housing having a cavity, wherein the second housing is fixed to the first housing such that the rechargeable battery and the main PCB are received in the cavity.

2. The mobile power according to claim 1, further comprising a LCD lens disposed on the first housing and aligned with the LCD module.

3. The mobile power according to claim 1, further comprising a button disposed on the first housing, wherein the button is electrically coupled to the main PCB and is configured to switch on the power output to the digital device and activate the battery capacity inquiry.

4. The mobile power according to claim 1, further comprising a pad having one side attached to the main PCB and the other side attached to the LCD module.

5. The mobile power according to claim 1, further comprising a first fastener, wherein the main PCB is fixed to the first housing by the first fastener.

6. The mobile power according to claim 1, wherein the LCD module is provided with a first pin connector, the LCD module is coupled to the main PCB via the first pin connector.

7. The mobile power according to claim 1, wherein the storage module is provided with a second pin connector, the storage module is coupled to the main PCB via the second pin connector.

8. The mobile power according to claim 1, wherein the rechargeable battery is a three-cell battery, the rechargeable battery is attached to the second housing and is electrically coupled to the main PCB via wires.

9. The mobile power according to claim 1, wherein the first housing is provided with a latching portion on an edge thereof, the second housing is provided with an engaging portion on an edge thereof cooperating with the latching portion.
